(19) United States
(12) Patent Application Publication
(10) Pub. No.: US 2008/0231703 A1
(43) Pub. Date: Sep. 25, 2008

(54) FIELD WATCH APPARATUS

(75) Inventors: Asako Nagata, Chita-city (JP); Tsuneo Uchida, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/047,517

(22) Filed: Mar. 13, 2008

(30) Foreign Application Priority Data
Mar. 23, 2007 (JP) 2007-76904

(51) Int. Cl. H04N 7/18

(52) U.S. Cl. 348/148; 348/E07.086

(57) ABSTRACT

A field watch apparatus of vehicular use includes a camera and a mirror-integrated display unit. The mirror-integrated display unit is integrally disposed with a room mirror, and have two surroundings view monitors for displaying surroundings views that are captured by the camera. The mirror-integrated display unit is disposed at a position that is viewable from a driver's seat in a subject vehicle for intuitive recognition of other vehicles in the surroundings through the displayed image of the surroundings views.

### CROSS REFERENCE TO RELATED APPLICATION

The present application is based on and claims the benefit of priority of Japanese Patent Application No 2007-76904 filed on Mar. 23, 2007 the disclosure of which is incorporated herein by reference.

### FIELD OF THE INVENTION

The present disclosure generally relates to a field watch apparatus for use in a vehicle.

### BACKGROUND INFORMATION

A conventional field watch apparatus is disclosed, for example, in Patent document WO00/64715 (U.S. Pat. No. 7,161,616) published as an apparatus that composes various angle images derived from plural cameras on a subject vehicle for viewing the surroundings of the vehicle in a viewpoint changing manner. Further, other patent documents such as JP-A-2005-167309, JP-A-2001-055100 (U.S. Pat. No. 6,593,960), JP-A-2005-173880, and JP-A-2006-231962 disclose surroundings images utilized for target object monitoring by a monitoring apparatus that highlights the target objects on a monitor screen. The monitoring apparatus disclosed in those documents only show the captured image derived from the camera in the vehicle, thereby making it difficult to understand where the target object displayed on the screen exists relative to the subject vehicle unless a driver of the subject vehicle is fully aware of positional relationships between the cameras on the vehicle and image capture angle of the cameras.

### SUMMARY OF THE INVENTION

In view of the above and other problems, the present disclosure provides field watch apparatus that allows a driver of a subject vehicle to intuitively recognize a target object of monitoring quickly in a course of driving.

The vehicle surrounding watch apparatus of the present disclosure includes: a self vehicle capture unit disposed on a self vehicle and capable of capturing surroundings of the self vehicle; and a mirror-integrated unit. The mirror-integrated unit includes: a room mirror; and a display unit disposed at a position next to the room mirror in an integrated form with the room mirror. The display unit is capable of displaying a self vehicle surroundings image of the self vehicle derived from the self vehicle capture unit and the mirror-integrated unit is disposed at a viewable position from a driver's seat in a room of the subject vehicle.

In the apparatus of the present disclosure, because the image of the surrounding field is displayed on the display unit that is integrated with the room mirror, the image of the surroundings derived from the capture unit can be monitored together with the image reflected on the room mirror itself. The image displayed on the display unit for supplementing a dead angle of the room mirror or the like can be intuitively understood in terms of capture angle of the image based on a position of the display unit integrated with the room mirror which establishes a basis of integrated backward view for intuitive recognition of viewing direction or the like, thereby enabling a quick and detailed monitoring of the target object in the surroundings of the subject vehicle. That is, in other words, the combination and integration of the room mirror with the display unit provides the driver with much more information in a readily available manner in terms of sense of viewing direction and the like in comparison to viewing the room mirror and the captured image separately, thereby facilitating a monitoring function of the field watch apparatus.

### BRIEF DESCRIPTION OF THE DRAWINGS

Other objects, features and advantages of the present invention will become more apparent from the following detailed description made with reference to the accompanying drawings, in which.

FIG. 1 shows a block diagram of a field watch apparatus in an embodiment of the present disclosure;

FIG. 2 shows an illustration of an arrangement of cameras disposed on a vehicle with an angle of one of the cameras;

FIG. 3 shows an illustration of a mirror-integrated unit disposed on a room mirror;

FIGS. 4A and 4B show a perspective view and a cross-sectional view of the mirror-integrated unit;

FIGS. 5A and 5B show illustrations of other vehicle detection by using a radar;

FIG. 6 shows a sequence chart for entire processing of the field watch apparatus;

FIG. 7 shows a flowchart of warning contents determination processing used in a sequence in FIG. 6;

FIG. 8 shows an illustration of operation of the field watch apparatus based on images on a display unit; and

FIG. 9 shows a diagram of combined contents of warning according to driver's condition.

### DETAILED DESCRIPTION

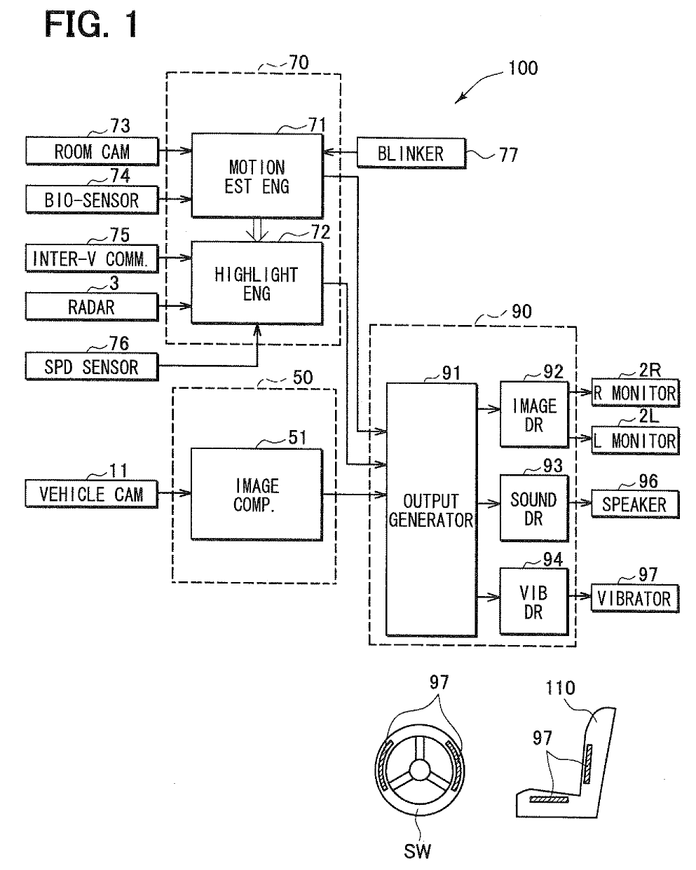

By referring to the drawings, embodiments of the present invention are described in the following. FIG. 1 shows a block diagram of a field watch apparatus 100 in an embodiment of the present disclosure, in terms of an electric configuration of function blocks. The field watch apparatus 100 is mainly governed by ECU's, that is, in the present invention, an image ECU 50, a driving action estimate ECU 70 and an output control ECU 90 are used with interactive connection through network. Each of the ECU's 50, 70, 90 is substantially formed as a well-known hardware of a microcomputer that includes a CPU, a ROM that stores software to be executed by the CPU, a RAM that serves as a work memory as well as an inputs and outputs unit under a bus connection throughout these components.

An in-vehicle camera group 11 is connected to the image ECU 50. In addition, an image composition unit 51 is realized as a software function in the image ECU 50. The image data of the in-vehicle camera group 11 is transferred to the image composition unit 51, a subject vehicle circumference image is composed based on the image data.

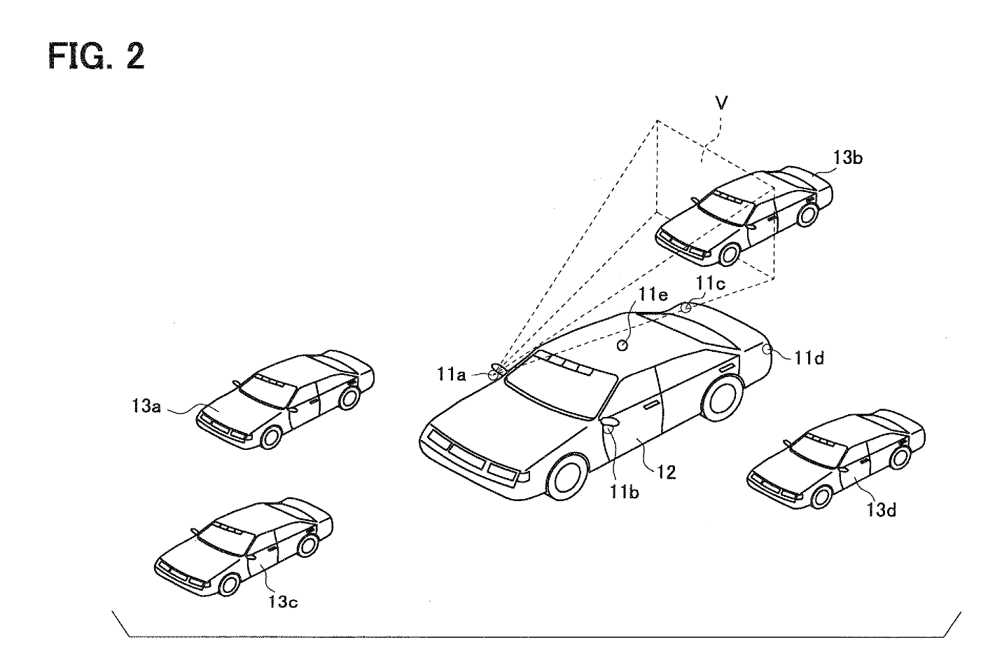

The in-vehicle camera group 11 constitutes a self vehicle capture unit to capture an image around a subject vehicle 12. Plural cameras in the camera group 11 respectively capture a field image to be composed as a continuous field view of immediate surroundings of the subject vehicle 12. FIG. 2 shows an illustration of an arrangement of cameras 11a-11e disposed on a body of the vehicle 12. The cameras are respectively designated as a front right camera 11a, a front left camera 11b, a rear right camera 11c, a rear left camera 11d, and a rear center camera 11e.

For example, the front right camera 11a is disposed at a position corresponding to a right side mirror, and it is disposed to capture a right side rear field of the subject vehicle 12 as a field of vision V, thereby providing an image that includes another vehicle 13b on a right backward of the vehicle 12 together with a part of the body of the vehicle 12. In the same manner, the front left camera 11b is disposed at a position corresponding to a left side mirror, and it is disposed to capture a left side rear field of the subject vehicle 12, thereby providing an image that includes another vehicle 13d on a left backward of the vehicle 12 together with a part of the body of the vehicle 12. Further, the rear center camera 11e captures vehicles and the like that runs right behind the vehicle 12. Furthermore, the rear right camera 11c and the rear left camera 11d serve to supplement a field of vision of the above front right camera 11a, the front left camera 11b and the rear center camera 11e. The captured images from these cameras 11a-11e undergo a three-dimensional viewpoint conversion to be composed as a self vehicle surroundings image that completely surrounds the self vehicle 12 without interruption from a virtual viewpoint for viewing backward of the vehicle 12. Details of the viewpoint conversion are disclosed in the above patent document of, for example, WO00/64715 (U.S. Pat. No. 7,161,616) and other documents. In addition, the number of cameras in the camera group 11 may be different from the number described above.

A radar 3 in FIG. 1 is a device for measuring distance toward a front vehicle and speed of the front vehicle by a laser or a millimeter wave, and the radar 3 detects the distance and/or the speed of the object of measurement in directions of front right/front left/rear right/rear left in a corresponding manner to the cameras 11a-11d. In addition, an inter-vehicle communication unit 75 directly communicates with vehicles in the surroundings of the vehicle 12 for transmission and reception of information of surrounding vehicles such as a vehicle size, speed, brake operation, accelerator operation, position coordinates, a model name, and a model number.

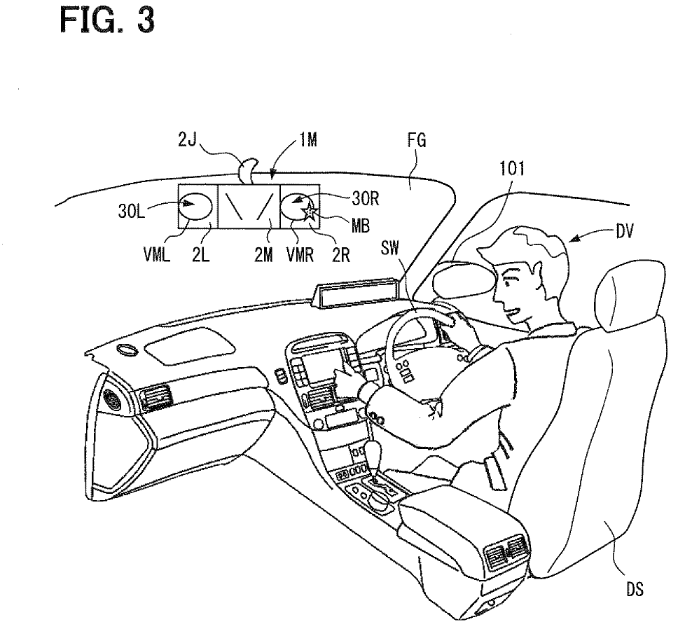

FIG. 3 shows an illustration of a mirror-integrated unit 1M disposed on a room mirror 2M as an example of the present embodiment. The mirror-integrated unit 1M is integrally disposed on the room mirror 2M as one body that does not allow separation of the unit 1M from the mirror 2M, and includes two monitors 2R, 2L for displaying the self vehicle surroundings images 30R, 30L that are captured by the cameras in the camera groups 11. The mirror-integrated display unit 1M is disposed at a position that is viewable from a driver's seat DS in the subject vehicle 12. More practically, the unit 1M includes a rear view mirror 2M at a position of an upper center part of a windshield FG in the vehicle 12.

The self vehicle surroundings images 30R, 30L derived from the camera group 11 includes an image that is biased, relative to a backward field image by the rear view mirror 2M, toward a right side in a vehicle width direction, that is, a rightward biased image 30R, and a leftward biased image 30L that is biased toward a left side in the vehicle width direction. Further, the monitors 2R, 2L are more specifically, a rightward biased screen 2R, and a leftward biased screen 2L respectively disposed on the right side edge and the left side edge of the mirror 2M. The rightward biased image 30R and the leftward biased image 30L are mainly generated from an image that is captured respectively by the rear right camera 11c and the rear left camera 11d. More practically, the images 30R, 30L includes a cut-out image from the self vehicle surroundings image that continuously surrounds the self vehicle after a composition and viewpoint conversion of the image from plural cameras, thereby including images from other cameras from the ones specified above. In addition, in the present embodiment, pseudo images VMR, VML of frame bodies of right and left mirrors are displayed on the screens 2R, 2L, so that the images 30R, 30L are displayed in a wrapped manner in the pseudo images VMR, VML of mirror frames.

The rear view mirror 2M is a laterally long shape half mirror 50 that includes, together with the right and left screens 2R, 2L, an intermediate area 51M between the right screen 2R and the left screen 2L as shown in FIG. 3. The image displayed on each of the screen 2R, 2L is seen through the half mirror 50. When the right screen 2R and the left screen 2L are non-display condition, the entire surface of the half mirror 50 can be used as a rearview mirror. That is, the intermediate area 51M as mentioned above and the right and left screens 2R, 2L can be used as the rear view mirror.

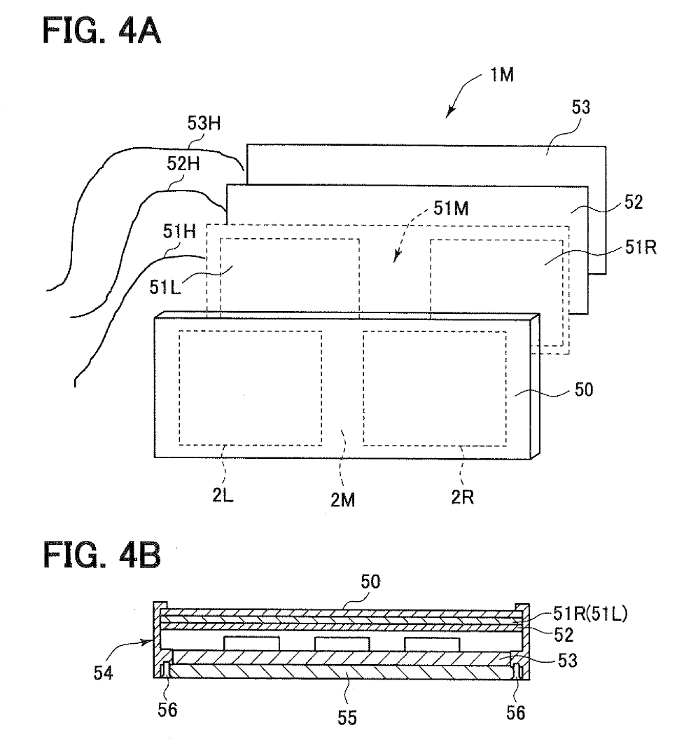

In addition, in FIG. 4A, the left screen 2R and the right screen 2L are respectively formed as a liquid crystal display (a liquid crystal panel) having a backlight 52 attached thereto. By lighting and not lighting the backlight 52, the half mirror area of the mirror 2M is extensively utilized as the rear view mirror when the backlight 52 is not lit. As shown in a cross section in FIG. 4B, on a back of the half mirror 50, a liquid crystal displays 51R, 51L, the backlight 52 and a control circuit board 53 are layered in this order to be covered by a housing frame 54. A back opening of the layered components is covered by a back lid 55 that is fixed with a screw 56 against the housing frame 54. In addition, wirings 51H, 52H, 53H respectively extending from the liquid crystal display 51R, 51L, the backlight 52 and the control circuit board 53 are placed in a stay 2J that is used for installing the mirror-integrated unit 1M in an inside of the vehicle 12 as shown in FIG. 4A.

FIG. 1 also shows connections of the driving action estimate ECU 70 to each of a room camera 73 in a vehicle compartment for capturing the face of the driver, the radar 3 and a bio-sensor group 74 (including, for example, a thermography imager, a temperature sensor, a sweat sensor, a skin resistance sensor, a heartbeat sensor and the like) for acquiring various kinds of biological information of the driver. In addition, the inter-vehicle communication unit 75 that is used to acquire image data, position data and the like is connected to the ECU 70 through communication interface.

Further, the driving action estimate ECU 70, a motion estimation engine 71 for estimation of driving operation, and a highlight engine 72 for highlighting the image are respectively realized as a software function. By the above configuration, biological conditions of the driver such as fatigue, sleepiness or the like may be linked to a threshold distance to other vehicles for warning provision. That is, the distance factor and driver's condition are both considered for warning provision.

The information on distance, direction and speed of the other vehicles from the radar 3 and/or the inter-vehicle communication unit 75 as well as the speed information of the subject vehicle 12 from the speed sensor 76 are transferred to the highlight engine 72.

Further, the image data from the room camera 73 and the biological information from the bio-sensor group 74 are transferred to the motion estimation engine 71. The motion estimate engine 71 extracts a pupil position from the face image of the driver captured by the camera 73, and, based on the pupil position, specifies the viewpoint of the driver. The technique of viewpoint identification is omitted because the technique is disclosed in detail in, for example, Japanese patent document JP-A-2005-167309. Furthermore, right and left turns as well as lane change of the subject vehicle 12 are determined based on a blinker signal from a blinker 77 that is inputted from the blinker 77 to the motion estimation engine 71.

The output control ECU 90 has connection to each of an image driver 92, a sound driver 93 and a vibration driver 94. In addition, as a software function, an output generator 91 for determining contents of output is realized. The self vehicle surroundings image from the image ECU 50 is transferred to the output generator 91. Further, from the motion estimation engine 71 in the driving action estimate ECU 70, an estimation result of the degree of risk of the approaching vehicle is transferred to the output generator 91. By referring to the degree of risk estimation result, the output generator 91 performs processes such as image data marking for warning of the other vehicle as well as data generation of sound output data and vibration control data respectively transferred to the image driver 92, the sound driver 93 and the vibration driver 94. In addition, from the subject vehicle circumference images 30, the rightward biased image 30R and the leftward biased image 30L are cut out to be output to the above-mentioned display screens 2R, 2L respectively connected to the image driver 92.

Further, the warning sound by the sound output data is output from a speaker 96 connected to sound driver 93 (a speaker in Audio Visual system may be utilized as the speaker 96). The vibration driver 94 which has received the vibration control data drives a vibration unit 97 connected thereto. The vibration unit 97 is installed in, for example, a steering wheel SW or a seat 110 (at a back support portion or a sitting surface) for directly transmitting warning vibration to the driver to effectively facilitate driver's recognition of warning and/or to raise driver's awakening level.

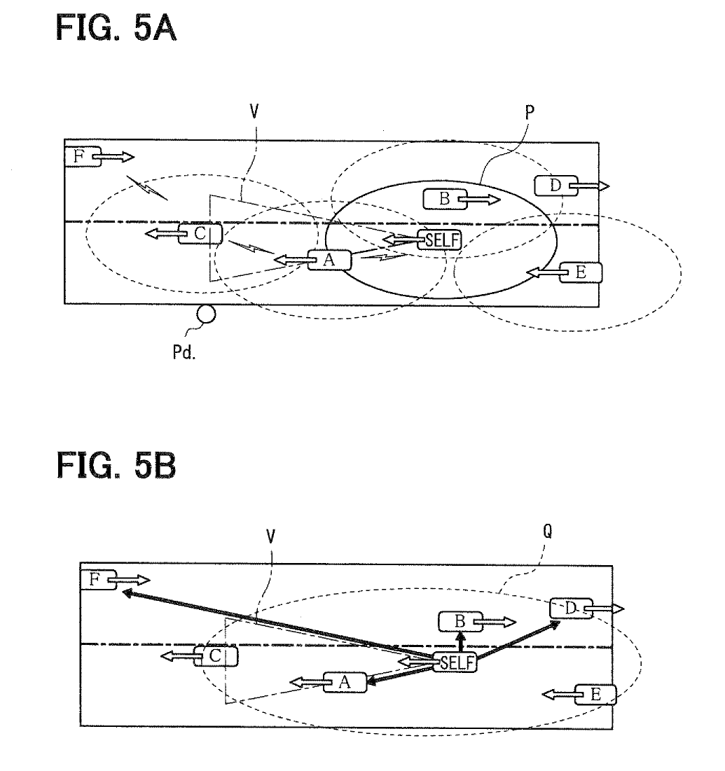

FIGS. 5A and 5B show a method to calculate the position (distance and direction) of the other vehicles in the surroundings. First, in the measurement of the distance to the other vehicles, transmission electricity power from the inter-vehicle communication unit 75 of the subject vehicle 12 is changed regularly for detecting the distance based on a detection of non-transmission electricity threshold that defines the level of non-transmission of the inter-vehicle communication. In this case, the inter-vehicle communication unit 75 disposed at the center of backward lamps, for example, makes it easier to accurately measure the inter-vehicle distance based on the communication with the front vehicle, due to the ease of detection result matching between the detection result of the inter-vehicle communication and the detection result of the radar 3. When the radar 3 is compared with the communication unit 75, a measurement range V of the radar 3 is longer than a communication range P of the communication unit 75, thereby first detecting and determining the distance and direction of the inter-vehicle communication by the radar 3 as a preparation for the actual inter-vehicle communication by the communication unit 75. In this manner, the transmission electricity power and the communication direction (Q) of the inter-vehicle communication unit 75 can be set. (“Pd” represents a pedestrian on a sidewalk.)

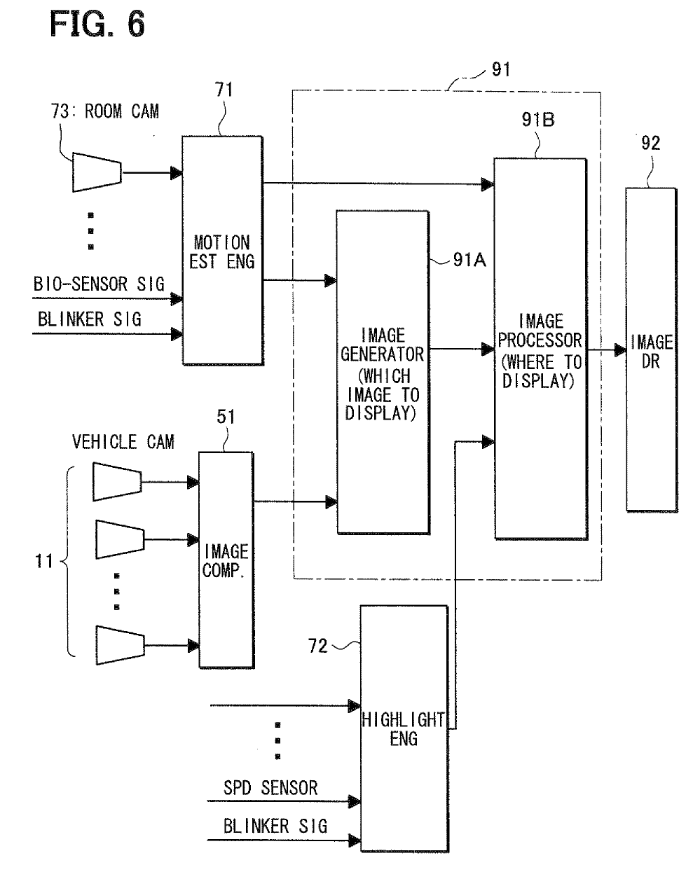

Operation of the field watch apparatus 1 is explained in the following. FIG. 6 shows a flowchart of the entire processing. First, the captured image from the camera group 11 is acquired by an image composition unit 51 for performing a well-known process of viewpoint conversion and composition. Then, other vehicles are extracted in each of the viewpoint converted images by a well-known image analysis method.

On the other hand, in the motion estimation engine 71, the viewpoint of the driver is identified in the image from the room camera 73, and lane change direction or a right/left turn direction is identified from the contents of the blinker signal. In an image generator 91A of the output generator 91, the self vehicle surroundings image after image composition is received from the image composition unit 51, and driver's viewpoint information is received from the motion estimation engine 71. Then, whether the driver's viewpoint is either at a center of a lane (that is, the driver is watching a currently traveling lane) or is biased to one of a front right lane and a front left lane is determined. When the viewpoint is biased one of the two front lanes, processing of other vehicle marking for warning (described later) is performed to output an other vehicle marking image for the biased side image, that is, either of the rightward biased image 30R or the leftward biased image 30L. Further, when the blinker signal indicating a lane change is detected, a start of the lane change is predicted and cut out positions of the rightward biased image 30R and the leftward biased image in the self vehicle surroundings image are determined. In this case, the cut out positions of the biased images are shifted rightward or leftward by a predetermined amount when the lane change to the right lane or the left lane is detected.

Further, the motion estimation engine 71 acquires, from the bio-sensor group 74, biological condition detection information of the driver. Because the driver's condition estimation based on the detection result of the biological condition is a well-known technique, the estimation method is described only as an outline in the following. The bio-sensor group 74 may include:
Infra-red sensor: a thermo-graphical image is captured by the infrared sensor for detecting the body temperature based on the radiated infrared ray from the face portion of the driver. The sensor serves as a temperature measurement unit.
Face camera (the room camera 73): the camera is used to capture a facial expression of the driver who is sitting in the driver's seat. Further, the look direction of the driver is used for detecting the level of attentiveness of the driver.
Microphone: the microphone is used to pick up the voice of the driver.
Pressure sensor: the pressure sensor is disposed at a position to be grasped by the driver on the steering wheel or the shift lever for detecting the grasping force as well as a frequency of grip and release.
Pulse sensor: a reflective light sensor or the like is used as the pulse sensor at the grasping position on the steering wheel of the vehicle for detecting the blood stream of the driver that reflects the pulse.
Body temperature sensor: the temperature sensor is disposed at the grasping position on the steering wheel.

The driver's condition is determined, for example, based on the captured image in the following manner. That is, captured image of the driver's face (as a whole or as a part of the face such as an eye, a mouth or the like) from the face camera is compared with master images that templates various psychological conditions and/or physical conditions to determine that the driver is in an anger/serenity, in a good temper (cheerfully)/in a bad temper (in disappointment or sorrow), or in anxiety/tension. Further, instead of applying a particular master image for respective users (i.e., the driver), extracting a facial outline, an eye shape or iris shape, a mouth/nose position/shape as common facial characteristics for all users and comparing the extracted facial characteristics with predetermined and stored standard characteristics of various physical/psychological conditions may also be used to determination of the same kind.

The body movement may be detected based on the moving picture of the user that is captured by the face camera (e.g., a shivering movement, a frowning) and/or information from the pressure sensor or the like (e.g., a frequent release of the hand from the steering wheel, or the like) for determining that the user is irritated or not while he/she is driving the vehicle.

The body temperature is detected either by the body temperature sensor on the steering wheel or by the thermo-graphic image from the infra-red sensor. The body temperature may rise when the user's feeling is lifted, strained, excited, or offended, and may moderately drop when the user's feeling is kept in calm. In addition, the strain and/or the excitement may be detected as the increase of pulse counts from the pulse sensor.

Further, the body temperature may rise when the user is in a physical condition such as being tired or in distraction regardless of the psychological condition. The cause of the temperature rise may be determined based on the combination of the facial expression (from the face camera) or the body movement (from the face camera/pressure sensor) with other information that represents the user's condition. Furthermore, the temperature rise due to the strain, excitement or the emotional response may be distinguished as a temporal temperature increase from the stationary fever due to a poor physical condition. In addition, when the user's normal temperature is being sampled and registered, the temperature shift from the registered normal temperature (e.g., a shift for higher temperature in particular) may enable a detection of more subtle emotional change or the like.

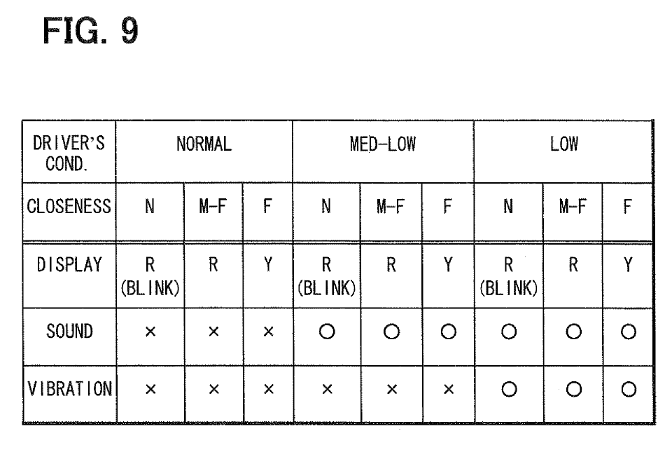

In the present embodiment, the physical/emotional condition detection result is used to classify the driver's condition into plural levels, that is, three levels of “Normal,” “Medium-Low,” and “Low” in this case, as shown in FIG. 9 for the risk estimation, and for providing a suitable warning for respective levels. More practically, the warning is provided only from the monitor when the user's condition is classified as “Normal,” with the addition of voice warning when the user's condition is classified as “Medium-Low,” and further with the vibration when the user's condition is classified as “Low.” In addition, the threshold of closeness to the other vehicle in three levels of “Near (N),” “Medium-Far (M-F),” and “Far (F)” reflected in the risk estimation is defined in a manner that reserves a longer time for the user who is classified as the lower condition toward the classification of “Low.”

The highlight engine 72, then, calculates a relative approach speed of the other vehicle towards the subject vehicle by subtracting the subject vehicle speed from the speed of the other vehicle based on an information acquisition of the distance to the other vehicle and the speed of the other vehicle detected by the radar 3.

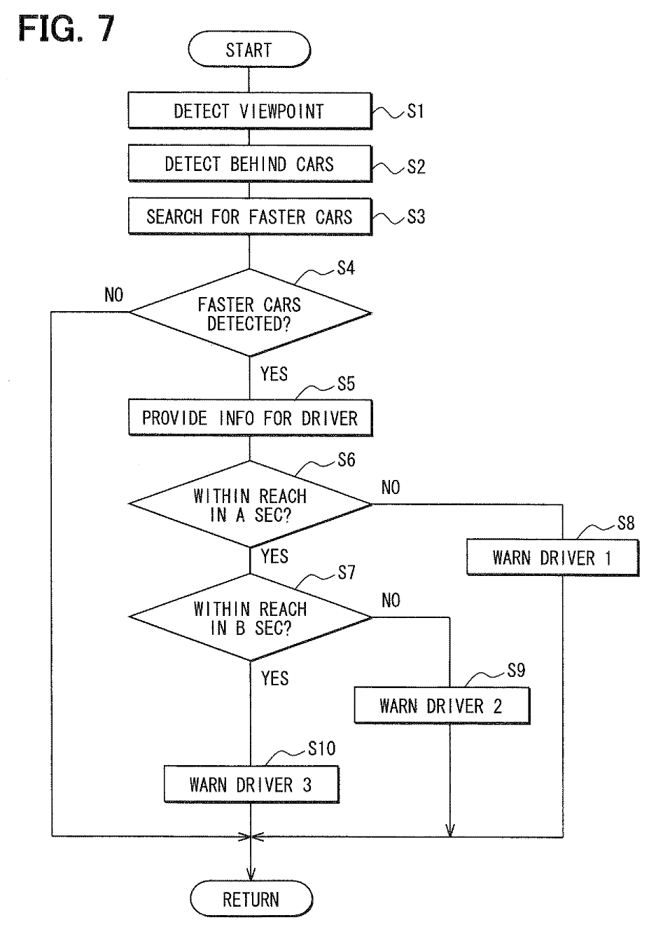

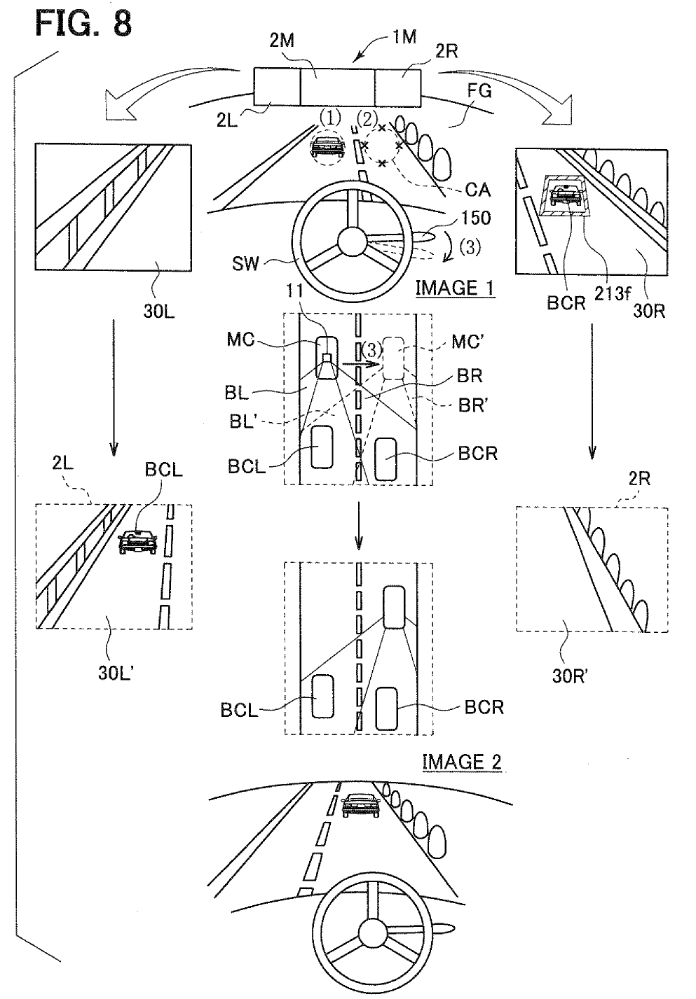

FIG. 7 shows a warning contents determination process. In the following description, an illustration in FIG. 8 is also referred to. The process is described as an example of lane change by the driver. The driver is, in this case, assumed to be looking at an identified viewpoint (1) as shown in the IMAGE 1 in FIG. 8. That is, the driver is assumed to be looking at a straight front field of the vehicle. For this straight viewpoint, the image from the camera group 11 is cut out as a field of vision BR and a field of vision BL that respectively correspond to a projection area of right and left side mirrors of the vehicle currently running at a position MC, and the cut-out images are displayed on the monitors 2R, 2L as the rightward biased image 30R and the leftward biased image 30L. The image 30R and image 30L may be referred to as pre-lane-change image hereinafter.

In S1 of the flowchart, the process determines whether the identified viewpoint (1) is shifted to a next lane as shown in FIG. 8 for at least a predetermined time for predicting the lane change. Then, the process confirms that other vehicle exists behind the subject vehicle in the self vehicle surroundings image 30 in S2. Then, the process determines whether a vehicle is that is faster than the subject vehicle is included in the image in S3. Then, the process proceeds from S4 to S5 for providing information including warning provision upon detecting the viewpoint (1) being shifted to the next lane in S1.

That is, in other words, time distance to the other vehicle is compared to the threshold of closeness for determination of the level of warning. The threshold of closeness is, for example, determined as exceeding A seconds (“Far”) for providing warning 1 by proceeding from S6 to S8, equal to or smaller than A seconds and more than B seconds (“Medium-Far”) for providing warning 2 by proceeding from S7 to S9, or smaller than B seconds (“Near”) for providing warning 3. More practically, as shown in FIG. 6, an image processor 91B performs a process on the cut-out image 30R or 30L for adding a warning color marking in a warning color (highlighted image) to an other vehicle image BCR. That is, the marking image is added to the vehicle image BCR in the rightward biased image 30R for the pre-lane-change viewpoint (or to an other vehicle image BCL in the leftward biased image 30L for the post-lane-change viewpoint) as shown in FIG. 8.

More practically, a marking frame 213f for outlining the other vehicle image BCR is distinguished for each of the warnings 1 to 3 depending on the time distance from the other vehicle. That is, when the other vehicle is classified as a time distance of “Far,” the marking frame 213f is displayed in yellow, and when the other vehicle is classified as a time distance of “Medium-Far,” the marking frame 213f is displayed in red. Further, when the other vehicle is classified as a time distance of “Near,” the marking frame 213f is displayed as a blinking frame in red.

In addition, the warning by the sound may be provided in combination when the driver's condition is determined to be lowered. The warning by the sound may encourage the driver DV to watch an other vehicle image MC in the screen of the monitor 2R (2L) when the other vehicle that is a subject of warning is highlighted. The sound warning may be provided as a simple alarm tone, or may be provided as a vocal output of concrete warning contents. For example, the vocal output may sound:

“Dangerous vehicle from behind”
(or “Warning: Faster car is approaching from behind.”),

“Vehicle is approaching. Keep the current lane.” or the like.

Further, the warning may be provided depending on the spatial distance instead of the distance of the catch-up time of the other vehicle, or may be provided depending on the speed of the other vehicle. Furthermore, the warning may be replaced with the numerical representation of the spatial distance or the speed of the other vehicle displayed on the screen.

Then, whether a blinker lever is operated for lane change is determined. That is, in other words, whether the blinker signal is output is determined. When the blinker lever is operated, on an assumption that the lane change is intended, the viewpoint conversion is performed so that the self vehicle surroundings image 30 has the post-lane-change viewpoint by virtually shifting the position of the cameras in the camera group 11 to the position that is indicated by the broken line in FIG. 8. Then, from the image after the viewpoint conversion, the field of visions BR, BL respectively corresponding to the side mirror projection area of the vehicle MC′ that has virtually moved to the next lane are cut out. As a result, on the monitors 2R, 2L in FIG. 8, the rightward biased image 30R′ and the leftward biased image 30L′ are displayed. The situation is also described as a top view in an IMAGE 2 in FIG. 8.

The image switching process for the viewpoint change may be performed in a continuous manner that accords with a virtual lane change of the vehicle from the current lane to the next lane. That is, display of the rightward biased image 30R and the leftward biased image 30L may be slid to display of the images 30R′ and 30L′ that have the post-lane-change viewpoint. When the viewpoint change is used as a trigger of the image switching, the viewpoint change may be configured to be in synchronization with the flow of vision field change in a continuous manner.

The image display condition described above may be maintained after the actual lane change of the vehicle. That is, the virtual viewpoint change prior to the actual lane change may be kept unchanged after the actual lane change that follows the virtual change. On the other hand, when the lane change has not been performed, the following process will, for example, follow.

(1)
If a blinker is turned off, the pre-lane-change image is restored.
(2)
If the viewpoint returns to the straight front, regardless of the cancellation of the blinker, the pre-lane-change image is restored.

Although the present invention has been fully described in connection with the preferred embodiment thereof with reference to the accompanying drawings, it is to be noted that various changes and modifications will become apparent to those skilled in the art.

For example, though the embodiment and the modifications are described as an example implemented to a field watch apparatus, the present invention may also be applicable to a field use apparatus that utilizes a captured image from a camera together with a view of a mirror for facilitating a visual recognition of a distant object or the like.

Such changes and modifications are to be understood as being within the scope of the present invention as defined by the appended claims.

What is claimed is:

1. A vehicle surrounding watch apparatus comprising:
a self vehicle capture unit disposed on a self vehicle and capable of capturing surroundings of the self vehicle, and
a mirror-integrated unit that includes:
a room mirror; and
a display unit disposed at a position next to the room mirror in an integrated form with the room mirror,
wherein the display unit is capable of displaying a self vehicle surroundings image of the self vehicle derived from the self vehicle capture unit, and
the mirror-integrated unit is disposed at a viewable position from a driver's seat in a room of the subject vehicle.

2. The vehicle surrounding watch apparatus of claim 1, wherein
the display unit in the mirror-integrated unit displays an image of a view based on an image derived from the self vehicle capture unit, and
the view represents a field of vision that is un-projectable on a virtual mirror if the virtual mirror is disposed at a position of a display screen of the display unit.

3. The vehicle surrounding watch apparatus of claim 1, wherein
the room mirror serves as a rear view mirror, and
the mirror-integrated unit is disposed at a position that faces an upper center portion of a windshield of the self vehicle.

4. The vehicle surrounding watch apparatus of claim 3, wherein
the self vehicle surroundings image captured by the self vehicle capture unit is biased toward a side of the self vehicle relative to a backwardly projected vision field of the rear view mirror to include a biased rear field image, and
the display screen of the display unit in the mirror-integrated unit displays the biased rear field image is disposed on a corresponding side of the rear view mirror in terms of a biased side of the biased rear field image in a vehicle width direction of the self vehicle.

5. The vehicle surrounding watch apparatus of claim 3, wherein
the self vehicle surroundings image captured by the self vehicle capture unit includes a rightward image of a rightward biased field relative to the backwardly projected vision field of the rear view mirror and a leftward image of a leftward biased field relative to the backwardly projected vision field of the rear view mirror, and
the mirror-integrated unit has a right screen and a left screen of the display unit respectively disposed on a right side and a left side of the rear view mirror for displaying an image of the rightward biased field and an image of the leftward biased field.

6. The vehicle surrounding watch apparatus of claim 5, wherein
the self vehicle capture unit includes a rightward field capture camera for capturing an image of a rightward field and a leftward field capture camera for capturing an image of a leftward field respectively independently.

7. The vehicle surrounding watch apparatus of claim 6, wherein
the right screen and the left screen of the display unit respectively display a simulated frame image that simulates a mirror frame of a side mirror on a right side and a left side, and
the simulated frame image on the right side and the left side respectively include the image of the rightward field and the image of the leftward field.

8. The vehicle surrounding watch apparatus of claim 7, wherein
the rear view mirror is formed as a laterally elongated shape half mirror that integrally covers the right screen and the left screen together with a middle area between the right and left screens, and
the image of the rightward field and the image of the leftward image are respectively viewed through the half mirror.

9. The vehicle surrounding watch apparatus of claim 1 further comprising:
a condition information acquisition unit capable of acquiring condition information that reflects a travel condition of the self vehicle and an operation condition in the room of the self vehicle; and
a display control unit capable of displaying on the display unit the self vehicle surroundings image in an emphasizing manner according a content of the condition information based on the acquired condition information.

10. The vehicle surrounding watch apparatus of claim 9 further comprising:
an other vehicle identify unit capable of identifying an other vehicle that travels behind the self vehicle in the self vehicle surroundings image; and
a vehicle distance detection unit capable of detecting a distance toward the other vehicle, wherein
the display control unit outputs information of the detected distance in the emphasizing manner that distinguishes an identity of the other vehicle in the self vehicle surroundings image.

11. The vehicle surrounding watch apparatus of claim 1, wherein
the vehicle distance detection unit is a distance detection unit being capable of detecting the distance toward the other vehicle that is disposed separately from an image acquisition unit for generating the self vehicle surroundings image on the self vehicle.

12. The vehicle surrounding watch apparatus of claim 11, wherein
the distance detection unit is configured as a radar distance measurement device.

13. The vehicle surrounding watch apparatus of claim 9 further comprising:
a relative approach speed detection unit capable of detecting a relative approach speed of the other vehicle from behind the self vehicle, wherein
the display control unit puts the image of the other vehicle in an emphasized warning condition in the self vehicle surroundings image when the other vehicle with the relative approach speed exceeding a predetermined positive approach speed threshold exists in the self vehicle surroundings image.

14. The vehicle surrounding watch apparatus of claim 13 further comprising:
an approach time distance estimation unit capable of estimating approach time distance information that reflects an approach time of the other vehicle from behind the self vehicle based on the distance detected by the vehicle distance detection unit and the relative approach speed detected by the relative approach speed detection unit, wherein
the display control unit puts the image of the other vehicle in the emphasized warning condition in the self vehicle surroundings image when the other vehicle with the approach time distance smaller than a predetermined threshold exists in the self vehicle surroundings image.

15. The vehicle surrounding watch apparatus of claim 9 further comprising:
a lane change direction prediction unit capable of predicting a lane change direction of the self vehicle, wherein
the room mirror serves as a rear view mirror,
the mirror-integrated unit is disposed at a position that faces an upper center portion of a windshield of the self vehicle,
the self vehicle surroundings image captured by the self vehicle capture unit is biased toward a side of the self vehicle relative to a backwardly projected vision field of the rear view mirror to include a biased rear field image,
the display screen of the display unit in the mirror-integrated unit displays the biased rear field image is disposed on a corresponding side of the rear view mirror in terms of a biased side of the biased rear field image in a vehicle width direction of the self vehicle, and
the display control unit displays, prior to a lane change, on the display screen the biased rear field image in a post viewpoint change condition with emphasis applied thereon by converting a current viewpoint of the biased rear field image from a vehicle position in a currently traveling lane to a virtual viewpoint from a vehicle position in a lane that is in accordance with the predicted lane change direction.

16. The vehicle surrounding watch apparatus of claim 9 further comprising:
a viewpoint detection unit capable of detecting a viewpoint of a driver in a driver's seat; and
a look direction detection unit capable of detecting a look direction of the driver based on the viewpoint detected by the viewpoint detection unit, wherein
the display control unit performs an image display control that provides an emphasized display condition of the biased rear field image that is in accordance with a shift direction when the look direction of the driver detected by the look direction detection unit is shifted away from a straight front toward one of a right side and a left side into the shift direction.

17. The vehicle surrounding watch apparatus of claim 16, wherein
the display control unit converts the biased rear field image to the field image with the viewpoint shifted in the shift direction and displays the field image after conversion in the emphasizing condition on the display screen.
